(19) United States
(12) Patent Application Publication
(10) Pub. No.: US 2025/0236765 A1
(43) Pub. Date: Jul. 24, 2025

(54) METHOD OF COATING WOOD UTILITY POLES FOR FIRE RESISTANCE

(71) Applicant: Michael James Anderson, Henderson, NV (US)

(72) Inventor: Michael James Anderson, Henderson, NV (US)

(21) Appl. No.: 18/806,511

(22) Filed: Aug. 15, 2024

Related U.S. Application Data
(60) Provisional application No. 63/520,129, filed on Aug. 17, 2023.

(51) Int. Cl. C09D 195/00; C09D 5/02; E04H 12/04

(52) U.S. Cl. CPC C09D 195/005; C09D 5/021; C09D 5/022; E04H 12/04

(57) ABSTRACT

A method of coating wooden utility poles with rubber-modified emulsified-asphalt materials that act as a fire-retardant coating to protect against combustion up to 1100° F. or more, in order to extend the life of wood utility poles in the field. The rubber-modified asphalt emulsion may be applied to at least a portion of a wooden utility pole by spraying, rolling, brushing, etc., then dried and cured. The rubber modification includes a halogenated elastomer and a diene elastomer.

### BACKGROUND OF THE INVENTION

This invention relates generally to methods of applying fire resistant coatings on wooden utility poles, more particularly to application of rubber-modified asphalt emulsions to wooden utility poles.

Forest and brush fires are common especially in the western region of the United States. Such fires may damage or even destroy wooden utility poles, resulting in expensive replacement costs, power outages, and damage to the power grid.

Some proposed solutions to make utility poles more resistant to these fires include wire mesh for thermal dispersion and insulative foam.

An example of the insulative foam approach is the use of a fire-retardant, polyurethane foam sprayed onto the utility pole. This approach has some shortcomings, including lack of resistance to the gaffs or spurs on linemen's climbing boots. Boot gaffing can crush and pierce the foam and destroy its fire-retardant properties. Undamaged polyurethane foam can retain moisture resulting in wood rot. Polyurethane foams also have limited fire resistance above about 800° F.

The wire mesh approach involves wrapping poles with a wire mesh, something like fencing material. It is reported to wick or disperse heat into the air as fast-moving fires pass by. It is reportedly resistant to gaffs but tends to abrade fabric and flesh, thereby annoying line workers. It may not retard fire to any great degree. FIG. 3 illustrates wire mesh on a utility pole with a gaff wound.

Other conventional approaches involve various coatings including conventional fire retardants. Typical of the art are U.S. patent Ser. No. 10/995,221 B2 and U.S. Pat. Pub. No. 2014/0076587 A1.

What is needed is a coating method for improving fire-resistance for wooden utility poles.

### SUMMARY OF THE INVENTION

The present invention is directed to systems and methods which provide an improved fire-retardant coating method for wooden utility poles.

The invention is directed to a method of coating wooden utility poles with neoprene-asphalt polymer compounds as a fire retardant coating that can protect against combustion up to 1100° F. or more, degrading slowly when exposed to flame and self-extinguishing when the flame is removed and/or the external temperature drops, thus retaining integrity as an oxygen barrier as long as it continues to resist full degradation, preventing/delaying combustion of the wooden pole. This can extend the life of utility poles in the field.

The inventive method includes applying a rubber-modified, asphalt emulsion to at least a portion of a wooden utility pole; permitting the rubber-modified, asphalt emulsion to dry on the wooden utility pole; and permitting the rubber-modified, asphalt emulsion to crosslink on the wooden utility pole.

In one embodiment the emulsion is an aqueous emulsion including a halogenated elastomer and a diene elastomer as the rubber modifier and may include a crosslinker, a catalyst and/or other components.

In preferred embodiments the halogenated elastomer may be polychloroprene, and the diene elastomer may be a styrene butadiene copolymer.

The method of applying the rubber-modified, asphalt emulsion may be by spraying (including cold spraying), rolling, dipping, spreading with a blade, or brushing.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a drawing of two wood utility pole sections on a test rack coated according to an embodiment of the invention;

FIG. 2A is a before-coating drawing of a wood utility pole used in a gaffing test;

FIG. 2B is an after-coating drawing of a wood utility pole used in a gaffing test according to an embodiment of the invention; and

FIG. 3 is a drawing of a prior-art pole-protection method after a gaffing test.

### DETAILED DESCRIPTION

The invention is directed to fire-retardant coating methods for wooden utility poles. Utility poles are vulnerable to damage and destruction from brush and forest fires. The inventor discovered that rubber-modified, emulsified asphalt coatings can make wooden utility poles much more fire resistant and therefore less likely to need to be replaced subsequent to a forest or brush fire. Exemplary rubber-modified asphalt-based coatings, when dried and cured, can resist burning with a flash point over 1100° F. Fire may degrade the coating slowly, while still protecting the wood substrate. The coating may self-extinguish when external temperatures subside and/or the external flame source is removed. The coating may also enable vapors (such as water vapor) to transpire, thus preventing or reducing wood rot. The coating is UV resistant and may be long lived once applied. When fire degrades the coating the smoke and gases produced may be toxic, but in the absence of flame, only non-toxic gases are released by the material. Over time, in air, ground and water, no toxicity is produced by the cured coating. It is thus wild-life friendly, environmentally safe, and non-toxic. The coating can be applied by brush, roller, blade, dip, or spray. Crosslinkers may be included, and curing (drying and/or hardening) time may be a few hours in air alone. The coating can also be catalyzed to accelerate curing and be dry to the touch and nontransferable in as fast as 3 minutes with full curing occurring commensurately. The dry coating is highly elastic and when stretched rapidly assumes its original shape (dimensional or elastic memory). This results in self-healing properties, so that when pierced by gaffs or other spikes, only tiny holes may remain from the wounds, thus preserving its fire-retardant properties.

The first main component of the useful coatings for the inventive method is asphalt or bitumen, particularly emulsified asphalt or bitumen. The emulsion may comprise from 50% to 95% total solids by weight in water, or from 50% to 90%, or 50% to 80%. Any known method of mixing and stabilizing the emulsion may be used, including known grades or sources of asphalt, addition of emulsifying agents, surfactants or stabilizers, cutting solvents, and the like.

The second main component is a rubber component, which may be a blend of rubber components. The rubber component preferably includes a halogenated elastomer such as polychloroprene (also known as neoprene or “CR”), bromobutyl, chlorobutyl, chlorinated polyethylene (CPE), chlorosulfonated polyethylene (CSM), a fluoroelastomer (FKM), or the like. The halogenated elastomer may be provided as a latex, emulsion, or liquid rubber, and it may be added during emulsification of the asphalt. The rubber component also preferably includes a diene rubber component, such as natural rubber (NR), polyisoprene (IR), isobutylene isoprene rubber (IIR), nitrile rubber (NBR), styrene butadiene copolymer (SBR) or the like. The diene elastomer may be provided as a latex, emulsion, solution, solid, or liquid rubber, and it may be added during emulsification of the asphalt. The halogenated rubber component increases the fire resistance of the coating and the use of a diene rubber component is useful for adjusting various properties as needed for the application. For example, the blend of two types of rubber permits a good balance of properties such as fire-resistance, viscosity and flowability of the emulsion, firmness or sag or slump of the coating, self-healing ability, tackiness after cure, elongation and tensile strength, and the like. The amount of the rubber component(s) may be 5% to 35%, or 10% to 30%, on a wet weight basis in the aqueous emulsion.

Other components may be included as needed in lesser amounts. Preferably, a crosslinker or curative, or curative package, is included. Crosslinking the rubber after application to the utility pole increases the stability, strength and durability of the coating, as well as the resistance to gaffing and the ability to self-heal. Any suitable crosslinking system for the elastomers chosen may be used. The crosslinking system may include accelerators or catalysts to increase the speed of the reaction.

Other fire-retardant additives could be added, but generally may not be needed.

There are numerous textbooks and references manuals known to those of skill in the art for formulating coatings. The useful coatings are broadly related or similar to rubber-modified asphalt emulsions used as waterproofing on concrete surfaces, roofs, foundation walls, and as surface coatings on asphalt roads, but modified considerably for use on vertical wood poles and to be more fire resistant. “The Vanderbilt Latex Handbook,” and R. Joseph, “Practical Guide To Latex Technology,” (2013), are useful for water-based rubber formulations, including crosslinking systems. R. F. Ohm, “The Vanderbilt Rubber Handbook,” (13^{th} Ed. 1990) is likewise useful for information on solid rubber and the many types of rubber. Both have been published in multiple editions over the years. Asphalt emulsions and other asphalt materials are described in James G. Speight, “Asphalt Materials Science and Technology,” (2015), and in J. Keith Davidson, “Introduction To Asphalt Emulsions,” (1995) available at www.mcasphalt.com. These are incorporated by reference herein.

### EXAMPLES

A five-gallon sample of a neoprene-modified asphalt emulsion was obtained from a roofing product manufacturer in order to test the pole idea. A first set of experiments on the poles consisted of obtaining pieces of utility pole, cutting them into two-foot sections, and coating them with the neoprene/asphalt-based roofing material (see FIG. 1). One section was flame tested. Photo #1 in FIG. 1 shows the fire test setup.

A pole section was then taken to a burn lab and tested further with a blow torch in a test jig made for that purpose as illustrated in FIG. 1. The results were very good.

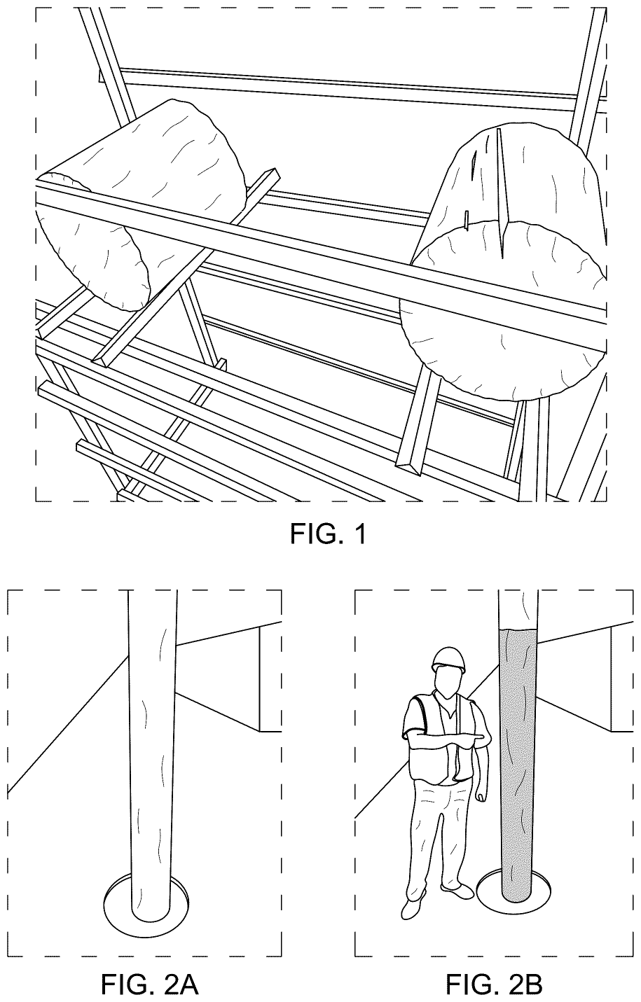

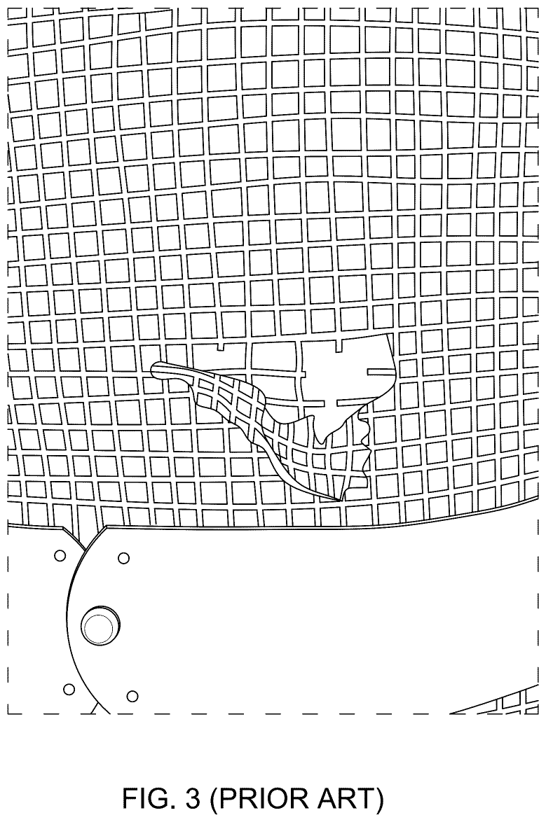

Linemen may use climbing spikes called gaffs to climb wooden poles. The next test was to coat a pole for a gaffing test. A pole setup for gaffing testing is illustrated in FIG. 2 (the pole before coating is on the left in FIG. 2, and after coating on the right in FIG. 2). The gaffing test demonstrated a satisfactory degree of self-healing. In contrast, FIG. 3 illustrates the severe damage done to a prior art wire mesh installation by a gaff.

In a more controlled burn test with an exemplary material optimized for fire resistance and spray application onto wood utility poles, the flash point was determined to be over 1300° F. and the material was found to be self-extinguishing. In addition, this coating material was found to result in a pole coating that was adhered well to wood whether coated or infused with creosote or other common treatments. The material also was not tacky when dried and did not slump or sag when sprayed on a vertical pole. The material was UV stable, appearing shiny when newly applied, and fading a little over time. The coating appearance can be renewed by applying another coating over a degraded coating, and/or it may be colored by applying a suitable topcoat. The coating can be sprayed cold, rolled on, spread with blade or squeegee, brushed on, or dipped. This material is marketed under the Pole Guard trade name by Pole Guard LLC of Henderson, Nevada.

It may be noted that the coating has some small amount of porosity and/or permeability to vapors. The porosity is believed to be less than 1%, maybe even less than about 0.1%. The porosity and permeability facilitates removal of volatiles such as water vapor from the coated substrate. In the case of wood utility poles, it may help prevent moisture rot. At the same time, this level of porosity is still considered substantially waterproof under liquid water exposure. Of course, wood rot may not be prevented if the pole is subjected to flooding or other continuous exposure to water.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A method comprising:
applying a rubber-modified asphalt emulsion to at least a portion of a wooden utility pole.

2. The method of claim 1 further comprising: permitting the rubber-modified asphalt emulsion to dry on the wooden utility pole.

3. The method of claim 1 further comprising: permitting the rubber-modified asphalt emulsion to crosslink on the wooden utility pole.

4. The method of claim 1 wherein the applying is carried out by spraying.

5. The method of claim 1 wherein the applying is carried out by rolling or brushing.

6. The method of claim 1 wherein the applying is carried out by dipping.

7. The method of claim 1 wherein the applying is carried out by blade coating.

8. The method of claim 1 wherein the rubber-modified asphalt emulsion is an aqueous emulsion.

9. The method of claim 1 wherein the rubber-modified asphalt emulsion is an aqueous emulsion comprising asphalt and modified with one or more rubbers selected from the group consisting of halogenated elastomers and diene elastomers.

10. The method of claim 9 wherein the rubber-modified asphalt emulsion comprises both a halogenated elastomer and a diene elastomer.

11. The method of claim 10 wherein the rubber-modified asphalt emulsion further comprises a crosslinker.

12. The method of claim 10 wherein the diene elastomer is a styrene butadiene copolymer, and the halogenated elastomer is polychloroprene.

13. A method comprising:
applying a rubber-modified asphalt emulsion to at least a portion of a wooden utility pole;
permitting the rubber-modified asphalt emulsion to dry on the wooden utility pole; and
permitting the rubber-modified asphalt emulsion to crosslink on the wooden utility pole.

14. The method of claim 13 wherein the rubber-modified asphalt emulsion is an aqueous emulsion comprising: a halogenated elastomer and a diene elastomer as the rubber modifier; and a crosslinker.

15. The method of claim 14 wherein the rubber-modified asphalt emulsion further comprises a catalyst to speed up crosslinking.

16. The method of claim 15 wherein the halogenated elastomer is polychloroprene.

17. The method of claim 16 wherein the diene elastomer is a styrene butadiene copolymer.

18. The method of claim 17 wherein the rubber-modified asphalt emulsion after drying and crosslinking is self-extinguishing in a flame test.

19. The method of claim 18 wherein the applying of the rubber-modified asphalt emulsion is by spraying, rolling, or brushing.
